(19) United States
(12) Patent Application Publication
(10) Pub. No.: US 2024/0384649 A1
(43) Pub. Date: Nov. 21, 2024

(54) METHOD AND SYSTEM FOR PREDICTING WATER PRODUCTION DATA AT DIFFERENT DEPTH INTERVALS IN A WELL USING MACHINE LEARNING

(71) Applicant: SAUDI ARABIAN OIL COMPANY, Dhahran (SA)

(72) Inventors: Mohammed A. Alghazal, Dammam (SA); Baraa Alsamman, Khobar (SA); Kanu Kingsley, Dhahran (SA)

(73) Assignee: SAUDI ARABIAN OIL COMPANY, Dhahran (SA)

(21) Appl. No.: 18/320,894

(22) Filed: May 19, 2023

(51) Int. Cl. E21B 47/117; G01V 99/00

(52) U.S. Cl. CPC E21B 47/117; G01V 20/00; E21B 2200/20; E21B 2200/22

(57) ABSTRACT

A method may include obtaining well log data for a well. The method may further include obtaining surface production data for the well based on a production operation. The well log data may be acquired at the well prior to the production operation being performed at the well. The method may further include obtaining a selection of a depth interval among various depth intervals in the well. The method may further include determining predicted production data for the depth interval in the well using a machine-learning model, the selection of the depth interval, the well log data, and the surface production data. The method further includes transmitting a command to a control system at the well based on the predicted production data.

### BACKGROUND

Multiphase flow data is a valuable metric for analyzing hydrocarbon production at a particular well as well as measuring the health of the well and the overall reservoir. However, collecting multiphase flow data at the surface may provide an inaccurate picture of different flows from different intervals within a reservoir. For example, a horizontal well may experience various water-influx regions at different depth intervals in the well. As such, water breakthroughs may result in rapid water-cut increasing, production decline, and an eventual water block off of a well. As such, surface well data alone may fail to detect the specific location of any water breakthroughs occurring inside the well.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining well log data for a well. The method further includes obtaining surface production data for the well based on a production operation. The well log data is acquired at the well prior to the production operation being performed at the well. The method further includes obtaining a selection of a depth interval among various depth intervals in the well. The method further includes determining, by a computer processor, predicted production data for the depth interval in the well using a machine-learning model, the selection of the depth interval, the well log data, and the surface production data. The method further includes transmitting, by the computer processor, a command to a control system at the well based on the predicted production data.

In general, in one aspect, embodiments relate to a method that includes obtaining a machine-learning model. The method further includes obtaining well log data for various wells. The method further includes obtaining surface production data for the wells. The method further includes obtaining acquired production logging tool (PLT) data for various depth intervals in the wells. The method further includes generating, by a computer processor, a trained machine-learning model using the machine-learning model, the well log data, the surface production data, and the acquired PLT data. The trained machine-learning model determines first predicted production data for a predetermined depth interval in a well. The machine-learning model is updated iteratively during various machine-learning epochs based on a comparison between a portion of the acquired PLT data and second predicted production data that are generated by the machine-learning model in a respective machine-learning epoch among the machine-learning epochs.

In general, in one aspect, embodiments relate to a system that includes a well control system coupled to a first well and a reservoir simulator that includes a computer processor. The reservoir simulator is coupled to the well control system and performs a method. The reservoir simulator obtains well log data for the well. The reservoir simulator further obtains surface production data for the well based on a production operation at the well. The well log data is acquired at the well prior to the production operation being performed at the well. The reservoir simulator further obtains a selection of a depth interval among various depth intervals in the well. The reservoir simulator further determines predicted production data for the depth interval in the well using a machine-learning model, the selection of the depth interval, the well log data, and the surface production data. The reservoir simulator further transmits a command to the well control system at the well based on the predicted production data.

In some embodiments, predicted production data is determined for a depth interval among various depth intervals. A determination may be made whether the depth interval is experiencing a water breakthrough based on the predicted production data. A command may be transmitted to a control system. The command may implement a remediation operation in response to determining that the depth interval is experiencing the water breakthrough. In some embodiments, rock matrix porosity data and fracture porosity data are determined using well log data for a depth interval in a well. Rock matrix permeability data and fracture permeability data may be determined using the well log data for the depth interval in the well. A petrophysical rock type may be determined for the depth interval. The rock matrix porosity data, the fracture porosity data, the rock matrix permeability data, the fracture permeability data, and the petrophysical rock type may be used by a machine-learning model to determine predicted production data for the depth interval.

In some embodiments, a height value above free water level of a depth interval is determined. First water saturation data of the depth interval may be determined prior to a production operation. Second water saturation data may be determined for the depth interval during the production operation. Water cut data may be determined using a water cut sensor during the production operation. The height value, the first water saturation data, the second water saturation data, and the water cut data may be used by a machine-learning model to determine the predicted production data for the depth interval. In some embodiments, predicted production data corresponds to a water entry at a depth interval in a well. In some embodiments, surface production data includes oil rate data, water rate data, and total flow rate data. The surface production data may be acquired using a multiphase flow meter. In some embodiments, a machine-learning model may be a random forest model that includes various decision tree nodes coupled using an ensemble method. The machine-learning model may be trained using a bootstrap and aggregation operation.

In some embodiments, a selection of a first depth interval and a second depth interval is obtained in a well. The first depth interval may be higher in the well than the second depth interval. First predicted oil rate data may be determined at the first depth interval using a machine-learning model, well log data, and surface production data. Second predicted oil rate data at the second depth interval may be determined using the machine-learning model, the well log data, and the second surface production data. The first predicted oil rate data may be greater than the second predicted oil rate data. In some embodiments, training data is obtained that includes well log data for various training wells, surface production data for the training wells, and acquired production logging tool (PLT) data for various depth intervals for the training wells. The acquired PLT data may be acquired using various production logging tools in the training wells. A training operation of an initial model may be performed using the training data to produce a machine-learning model. In some embodiments, well log data is acquired using a logging system coupled to a well. In some embodiments, a control system is coupled to a wellhead assembly. A command to the control system may adjust one or more production parameters in the wellhead assembly.

In some embodiments, rock matrix porosity data, rock matrix permeability data, petrophysical rock type data, fracture porosity data, and fracture permeability data are determined for various wells using well log data. A training dataset may be determined that includes the rock matrix porosity data, the rock matrix permeability data, the petrophysical rock type data, the fracture permeability data, and the fracture permeability data. The training dataset may be separated into various batches for various machine-learning epochs. In some embodiments, a water cut sensor is coupled to a well control system and a well. The water cut sensor may determine water cut data for the well.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2, and 3 show systems in accordance with one or more embodiments.

FIG. 4 shows a flowchart in accordance with one or more embodiments.

FIG. 5 shows an example in accordance with one or more embodiments.

FIG. 6 shows a flowchart in accordance with one or more embodiments.

FIGS. 7, 8, 9, 10, 11, 12, 13, and 14 show examples in accordance with one or more embodiments.

FIG. 15 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for predicting production data at different depth intervals in a wellbore using machine learning. In some embodiment, for example, a trained machine-learning model predicts a flow rate of both oil and water as a function of depth across a downhole interval of a wellbore. More specifically, a machine-learning model may use various input features for prediction data, such as data acquired when initially drilling the well, surface production data (e.g., surface oil and water production rates), and reservoir properties at different depth intervals (e.g., porosity of an interval's rock matrix as well as individual fractures adjacent to the depth intervals). By using predicted production data for different depth intervals below the surface, some embodiments may obtain insights into downhole conditions that are not available using only surface measurements. As such, a machine-learning model may predict production data among different depth intervals without using flowmeter surveys or expensive production logging tool (PLT) operations. Likewise, predicted production data may also provide a more accurate understanding of downhole flow rates than saturation-based synthetic models that do not accurately capture a well's flow profile (e.g., synthetic models may not learn from historical reservoir information and logging data).

Furthermore, predicted production data may be used to predict the existence or presence of a downhole water entry at a particular interval as well as the amount of water entry. More specifically, some embodiments solve the problem of measuring the downhole water flow in horizontal wells that may be stimulated to produce hydrocarbon production. Using a machine-learning model, a reservoir simulator may determine which depth intervals in a particular horizontal well have water flowing into the well stream. Using the predicted water flow data, production operations may be optimized throughout a horizontal well accordingly. For example, production may be increased at certain wells that are not experiencing downhole water breakthroughs, while production may be decreased or shutoff at wells with possible water entry inside the well. In some embodiments, various remediation procedures are performed in response to predicting a water breakthrough at a particular depth interval, such as a well intervention operation using special packers or in-flow control devices.

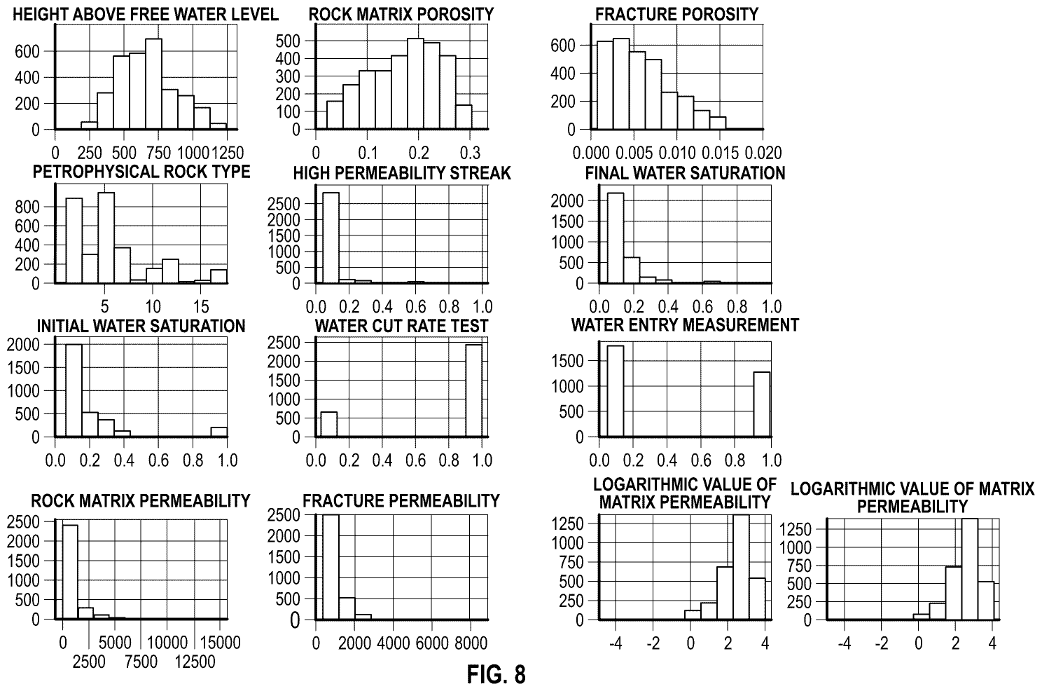

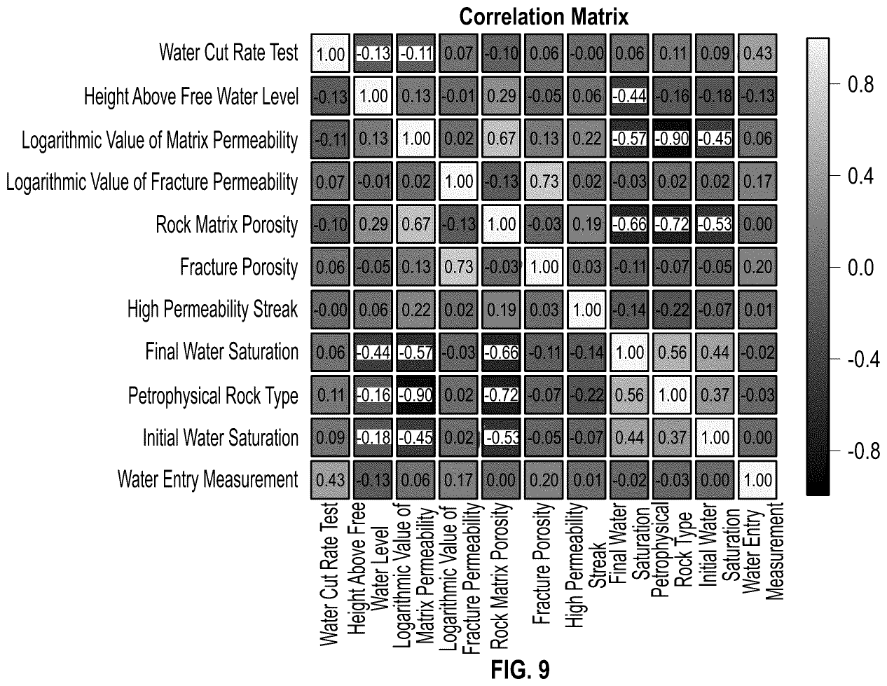

Prior to machine learning modeling, several visualization techniques have been used to explore the correlations and relationship between reservoir features and target variables, such as the example histogram shown in FIG. 8 and correlation heat map shown in FIG. 9. FIG. 8 shows a frequency distribution of each input variable. For example, permeability features are log transformed in FIG. 8 to remove the skewness in the distribution prior to machine learning modeling. Likewise, FIG. 9 shows a heat correlation map of the Pearson's coefficients calculated between feature-feature pairs and feature-target pairs. In FIG. 9, water flow is illustrated as being weakly correlated to all other features, except for the water cut from rate test which shows a correlation of 0.43. Thus, some embodiments overcome various shortcomings in well data acquisition for managing well performance and water breakthroughs using machine learning.

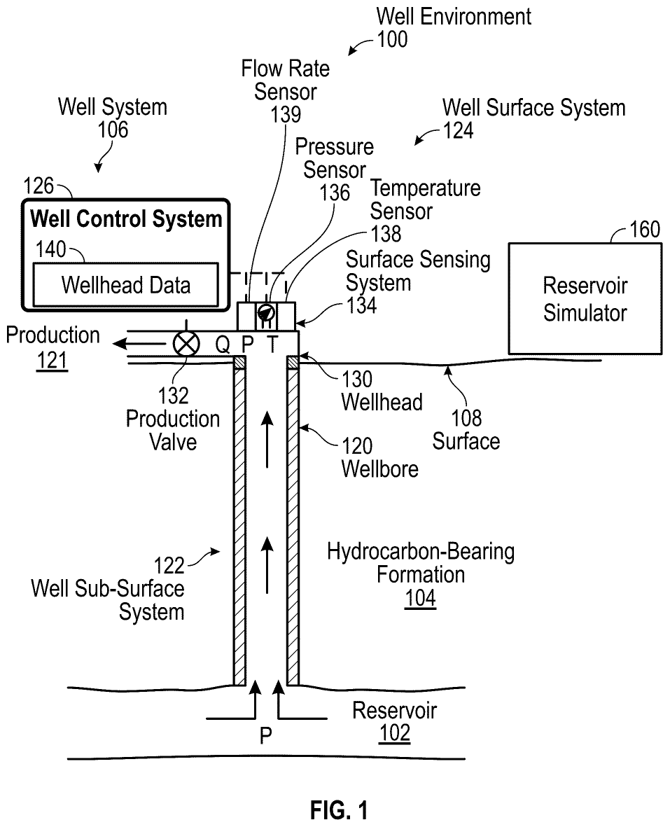

Turning to FIG. 1, FIG. 1 shows a schematic diagram in accordance with one or more embodiments. As shown in FIG. 1, FIG. 1 illustrates a well environment (100) that includes a hydrocarbon reservoir (“reservoir”) (102) located in a subsurface hydrocarbon-bearing formation (104) and a well system (106). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying properties, such as varying degrees of permeability, porosity, and resistivity. In the case of the well system (106) being operated as a production well, the well system (106) may facilitate the extraction of hydrocarbons (or “production”) from the reservoir (102).

In some embodiments, the well system (106) includes a wellbore (120), a well sub-surface system (122), a well surface system (124), and a well control system (126). The control system (126) may control various operations of the well system (106), such as well production operations, well completion operations, well maintenance operations, and reservoir monitoring, assessment and development operations. Control systems may include a programmable logic controller (PLC), a distributed control system (DCS), a supervisory control and data acquisition (SCADA), and/or a remote terminal unit (RTU). For example, a programmable logic controller may control valve states, fluid levels, pipe pressures, warning alarms, and/or pressure releases throughout a well facility or power-generation facility. In particular, a programmable logic controller may be a ruggedized computer system with functionality to withstand vibrations, extreme temperatures, wet conditions, and/or dusty conditions, for example, around a production well. A distributed control system may be a computer system for managing various processes at various facilities using multiple control loops. As such, a distributed control system may include various autonomous controllers (such as remote terminal units) positioned at different locations throughout the facility to manage operations and monitor processes. Likewise, a distributed control system may include no single centralized computer for managing control loops and other operations. On the other hand, a SCADA system may include a control system that includes functionality for enabling monitoring and issuing of process commands through local control at a facility as well as remote control outside the facility. With respect to an RTU, an RTU may include hardware and/or software, such as a microprocessor, that connects sensors and/or actuators using network connections to perform various processes in the automation system. Likewise, a control system may be coupled to one or more well devices.

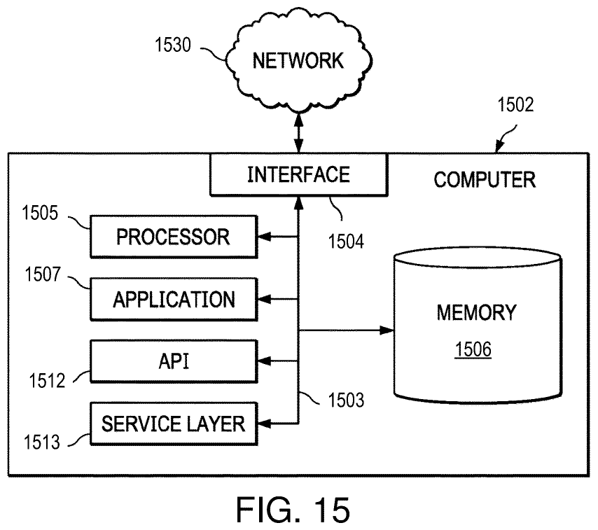

In some embodiments, a well control system includes functionality for transmitting commands to another control system to implement a particular production operation or stimulation operation. For example, a well control system coupled to a reservoir simulator may transmit a network message over a machine-to-machine protocol to a control system based on predicted flow rate data. A command may be transmitted based on a user input or automatically based on changes in production conditions, e.g., after analyzing new reservoir data, electric-power data, and carbon emission data. In some embodiments, the control system (126) includes a computer system that is the same as or similar to that of computer system (1502) described below in FIG. 15 and the accompanying description.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “uphole” end of the wellbore (120), and a lower end of the wellbore, terminating in the hydrocarbon-bearing formation (104), may be referred to as the “downhole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

In some embodiments, during operation of the well system (106), the control system (126) collects and records wellhead data (140) for the well system (106). The wellhead data (140) may include, for example, a record of measurements of wellhead pressure (P) (e.g., including flowing wellhead pressure), wellhead temperature (T) (e.g., including flowing wellhead temperature), wellhead production rate (Q) over some or all of the life of the well system (106), and water cut data. In some embodiments, the measurements are recorded in real-time, and are available for review or use within seconds, minutes or hours of the condition being sensed (e.g., the measurements are available within 1 hour of the condition being sensed). In such an embodiment, the wellhead data (140) may be referred to as “real-time” wellhead data (140). Real-time wellhead data (140) may enable an operator of the well system (106) to assess a relatively current state of the well system (106) and make real-time decisions regarding development of the well system (106) and the reservoir (102), such as on-demand adjustments in regulation of production flow from the well.

In some embodiments, the well surface system (124) includes a wellhead (130). The wellhead (130) may include a rigid structure installed at the “uphole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing. In some embodiments, the well surface system (124) includes flow regulating devices that are operable to control the flow of substances into and out of the wellbore (120). For example, the well surface system (124) may include one or more production valves (132) that are operable to control the flow of production (121). For example, a production valve (132) may be fully opened to enable unrestricted flow of production (121) from the wellbore (120), the production valve (132) may be partially opened to partially restrict (or “throttle”) the flow of production (121) from the wellbore (120), and production valve (132) may be fully closed to fully restrict (or “block”) the flow of production (121) from the wellbore (120), and through the well surface system (124).

Keeping with FIG. 1, in some embodiments, the well surface system (124) includes a surface sensing system (134). The surface sensing system (134) may include sensors for sensing characteristics of substances, including production (121), passing through or otherwise located in the well surface system (124). The characteristics may include, for example, pressure, temperature and flow rate of production (121) flowing through the wellhead (130), or other conduits of the well surface system (124), after exiting the wellbore (120).

In some embodiments, the surface sensing system (134) includes a surface pressure sensor (136) operable to sense the pressure of production (121) flowing through the well surface system (124), after it exits the wellbore (120). The surface pressure sensor (136) may include, for example, a wellhead pressure sensor that senses a pressure of production (121) flowing through or otherwise located in the wellhead (130). In some embodiments, the surface sensing system (134) includes a surface temperature sensor (138) operable to sense the temperature of production (121) flowing through the well surface system (124), after it exits the wellbore (120). The surface temperature sensor (138) may include, for example, a wellhead temperature sensor that senses a temperature of production (121) flowing through or otherwise located in the wellhead (130), referred to as “wellhead temperature” (T). In some embodiments, the surface sensing system (134) includes a flow rate sensor (139) operable to sense the flow rate of production (121) flowing through the well surface system (124), after it exits the wellbore (120). The flow rate sensor (139) may include hardware that senses a flow rate of production (121) (Q) passing through the wellhead (130).

In some embodiments, the well system (106) includes a reservoir simulator (160). For example, the reservoir simulator (160) may include hardware and/or software with functionality for generating one or more reservoir models regarding the hydrocarbon-bearing formation (104) and/or performing one or more reservoir simulations. For example, the reservoir simulator (160) may store well logs and data regarding core samples for performing simulations. A reservoir simulator may further analyze the well log data, the core sample data, seismic data, and/or other types of data to generate and/or update the one or more reservoir models. While the reservoir simulator (160) is shown at a well site, embodiments are contemplated where reservoir simulators are located away from well sites. In some embodiments, the reservoir simulator (160) may include a computer system that is similar to the computer system (1502) described below with regard to FIG. 15 and the accompanying description.

In some embodiments, downhole pressure sensors include absolute pressure transmitters, differential-pressure transmitters, and/or multivariable transmitters. Absolute pressure transmitters may include sensors that measure pressure with respect to a full vacuum, while differential-pressure transmitters may include sensors that are used in flow applications. Multivariable transmitters may measure pressure in addition to other variables, such as temperature. For example, a multivariable transmitter may be a gauge sensor that measures both pressure and temperature at a single point, such as a single quartz crystal. Multivariable transmitters may be transmit-only devices in a well providing pressure and temperature (PT) measurements at fixed time intervals, e.g., using one or more electric lines and one or more hydraulic lines. Likewise, multivariable transmitters may transmit pressure and temperature data to a well surface using a high-speed digital telemetry link. Similar to downhole pressure sensors, downhole temperature sensors may include downhole temperature gauges, temperature transmitters, and/or multivariable transmitters. In some embodiments, permanent downhole gauges (PDGs) are used that are permanently installed in a well and used to detect pressure data and/or temperature data.

In some embodiments, a flow rate sensor is a multiphase flow meter. For example, a multiphase flow meter may include hardware and/or software for determining individual flow rates of different components within a three-phase flow. More specifically, a multiphase flow meter may determine a mass flow rate of a gas component and a mass flow rate of a liquid component (e.g., a component of the three-phase flow that includes oil and water) of the three-phase flow. As such, a multiphase flow meter may be used to determine an amount of oil or a portion of oil within a multiphase flow that travels through a wellhead during a given period of time. A multiphase flow meter may also include hardware that uses various types of sensors based on different sensing technologies (e.g., nuclear magnetic resonance, electromagnetic sensors, acoustic sensors, etc.) and interpretation models. For example, a multiphase flow meter may use a sensor response of magnetic resonance information to determine the number of hydrogen atoms in a particular fluid flow. Since oil, gas, and water each contain hydrogen atoms, properties of a multiphase flow may be measured using magnetic resonance. The hydrogen atoms in a magnetized fluid may respond to radio frequency pulses and emit echoes that are subsequently recorded and analyzed by the multiphase flow meter. Thus, multiphase flow rate measurements may be used for production monitoring, well control, and/or reservoir optimization.

Moreover, a multiphase flow metering system may include a multiphase flow meter and a host device. In response to determining flow rate data regarding a multiphase flow, a multiphase flow meter may transmit flow rate data to a host device, such as a well control system or another type of computer system, over a network. The multiphase flow meter may be coupled to one or more flow tubes in order to determine the flow rate data, such as individual flow rates and/or oil, gas, and/or water fractions of a corresponding multiphase flow. A flow tube may be a fluid conduit, such as pipe, that may provide a fluid sampling for analysis by the multiphase flow meter. Examples of flow tubes may include a bent flow tube, a straight flow tube, or another type of flow tube. Furthermore, a flow model may be stored within a multiphase flow meter as a portion of a database and/or as one or more flow regime maps that are associated with various sensor values. By analyzing sensor data in connection with one or more flow models, a flow meter may determine flow rate data that corresponds to acquired sensor data. Flow rate data may include corresponding fractional data (e.g., gas fraction of a multiphase flow) and/or velocity data (e.g., an individual flow rate of oil or water in the multiphase flow).

Furthermore, the multiphase flow meter may include a flow meter controller that controls sensing operations and/or the flow analysis operations. In some embodiments, a flow controller uses one or more flow models to determine flow rate data regarding a particular flow. Phase distribution information may describe the respective fractions of one or more phases (e.g., gas phase, oil phase, water phase), in a particular flow. Flow regime information may refer to a specific manner that two or three phases flow through a flow tube. For example, a flow regime may be expressed using various superficial velocities. One example of a flow regime may be a “bubble regime,” in which gas is entrained as bubbles within a liquid. Another example of a flow regime is a “slug regime” that may correspond to a series of liquid “slugs” or “plugs” separated by relatively large gas pockets. Accordingly, a flow model may describe changes in a multiphase flow between transitions from high-liquid compositions to high-gas compositions and vice versa. Other flow regimes may include an annular flow regime, a dispersed flow regime, and a froth flow regime.

In some embodiments, one or more production logging tools (PLT) are used to determine production data at one or more depth intervals in a production well. For example, PLT data at a particular depth may include wellbore temperature measurements, pressure measurements, fluid density measurements, flow velocity measurements, and holdup data (e.g., volume fraction of a pipe occupied by fluid). While measurements of pressure, temperature and flow rate can be obtained at the surface, surface measurements may not necessarily reflect what is happening in the reservoir. As such, PLT data may be acquired downhole using various logging tools. More specifically, fluid velocity data may be acquired using a spinner flowmeter. In particular, a spinner flowmeter may include a rotating blade that turns when fluid moves past the device (e.g., the rotational speed of the blade in revolutions per second (RPS) may be proportional to the fluid velocity). Moreover, PLT data may be acquired using a production logging toolstring. This toolstring may include a fullbore spinner, various fluid holdup and bubble count probes, a pipe diameter caliper tool, a bearing sensor, a pressure sensor, a temperature sensor, a gamma ray tool, a casing collar locator, one or more batteries, and/or a data recorder. Other production logging tools include markers/tracers such as oxygen activation logs or radioactive iodine tracer logs as well as anemometers. An anemometer may be an instrument that measures the speed or velocity of gases in a contained flow. As such, PLT operations may include temperature logging, radioactive tracer logging, noise logging, focused gamma ray density logging, unfocused gamma ray density logging, fluid capacitance logging, fluid identification logging in high angle wells, and flowmeter logging at different depth intervals.

Keeping with production logging tools, various types of logging tools may be used to provide information during production operations and afterwards. For example, production logging may determine an axial flow rate based on axial velocity data and an internal diameter of a pipe component. Likewise, production logging may be used to track movement of fluid either inside or immediately outside the casing of a wellbore. Examples of production logs include temperature surveys, mechanical flowmeter surveys, and borehole fluid-density surveys, and fluid-capacitance surveys. Moreover, PLT data may be used to determine whether a production problem exists, such as excessive water or gas production. In particular, PLT data may be used to determine whether a production problem is the result of a completion problem or a reservoir problem. In some embodiments, production logging is used to determine the location of casing damage or collars. Likewise, PLT data may also determine water holdup in a wellbore or a well's gas volume fraction. Thus, PLT data may provide detailed, multiphase evaluation of fluid velocity and phase identification in vertical, deviated, and horizontal wells. More specifically, PLT data may identify fluid entry, gas leaks, injection zones, and cement tops through various well or reservoir analyses.

In some embodiments, the well system (106) includes a water cut sensor. For example, a water cut sensor may be hardware and/or software with functionality for determining the water content in oil, also referred to as “water cut.” Measurements from a water cut sensor may be referred to as water cut data and may describe the ratio of water produced from the wellbore (120) compared to the total volume of liquids produced from the wellbore (120). Water cut sensors may implement various water cut measuring techniques, such as those based on capacitance measurements, Coriolis effect, infrared (IR) spectroscopy, gamma ray spectroscopy, and microwave technology. Water cut data may be obtained during production operations to determine various fluid rates found in production from the well system (106).

With regard to microwave based water cut sensors, certain microwave-based water cut sensors may rely on measuring a phase difference between transmitted and received microwave signals. As such, the phase difference may have a direct link with the effective permittivity of the oil and water mixture from the wellbore (120). In some embodiments, microwave-based water cut sensors employ transmit (Tx) antennas and receive (Rx) antennas disposed inside of well system pipe, such that the antennas are at least partially immersed in the fluid mixture as the fluid flows through the pipe.

In some embodiments, the well system (106) includes a water cut sensing system that includes a water cut (WC) sensor, a cylindrical pipe, and/or a measurement processing system. The WC sensor may be disposed on (or otherwise integrated within) the cylindrical pipe. As such, the WC sensor may include a signal conductor (SC) (e.g., a first conductive plane), such as a T-resonator, disposed at a first/upper/top surface of the cylindrical pipe, and a ground conductor (GC) (e.g., a second conductive plane) disposed at a second/lower/bottom surface of the cylindrical pipe that is opposite the first/upper/top surface of the pipe. In such a configuration, the WC sensing system may be employed to sense a water cut of fluid obtained from the wellbore (120) (e.g., a water and oil mixture, or other substrate). In some embodiments, a WC sensor includes multiple waveguides that are attached to a production pipe, where a network analyzer may be connected to the waveguides. The network analyzer may be communicatively coupled with the well control system (126) to determine water cut data.

In some embodiments, production wells and/or injection wells are involved in one or more stimulation operations. For example, one type of stimulation operation is a water-alternating-gas (WAG) operation. A WAG operation may be a cyclic process of injecting water followed by gas. Using a WAG injection, macroscopic or microscopic sweep efficiency may be improved for a reservoir, e.g., by maintaining nearly initial high pressure, slow down any gas breakthroughs, and reduce oil viscosity. Likewise, WAG injections may also decrease residual oil saturation resulting from three phase flows and effects associated with relative permeability hysteresis. Thus, some stimulation operations may produce gas flooding, which is a type of enhanced oil recovery (EOR) method for increasing recovery of light to moderate oil reservoirs. In some stimulation operations, water may be injected during the initial phase of the operation and followed by a gas (e.g., carbon dioxide) because water may have a higher mobility ratio than the injected gas, thereby preventing breakthroughs in the reservoir. Injected gas may be a mixture of hydrocarbon gas or nonhydrocarbon gases. With hydrocarbon gases, the gas mixture may include methane, ethane, and propane for achieving a miscible or immiscible gas-oil system in the reservoir. With nonhydrocarbon gases, the gas mixture may include carbon dioxide (CO₂), nitrogen (N₂), and some exotic gases that displace fluid in the reservoir. Likewise, gas may also be injected directly into a reservoir, e.g., into the gas cap, to compensate for the reservoir's pressure decline.

Furthermore, a stimulation injection during a stimulation operation may correspond to various injection parameters, such as bank size, cycle time, and a predetermined water-gas ratio (also called a “WAG ratio”). Bank size may refer to a size of sequential banks of fluids (e.g., oil, CO₂ and water) formed in the reservoir rock in response to a stimulation operation that migrate from the injection to the production wells. For illustration, a WAG ratio of 1:1 may result in a high oil production for one or more production wells, such as production wells coupled to a miscible reservoir. Based on some reservoir parameters such as oil composition, gas flooding can be carried out in miscible or immiscible conditions. Moreover, different types of stimulation operations may use different stimulation parameters. Examples of different stimulation operations may include: (1) continuous gas injections; (2) WAG injections; (3) simultaneous water-alternating-gas (SWAG) injections; and (4) tapered WAG injections. Different strategies have been developed by the petroleum industry to cope with these conditions.

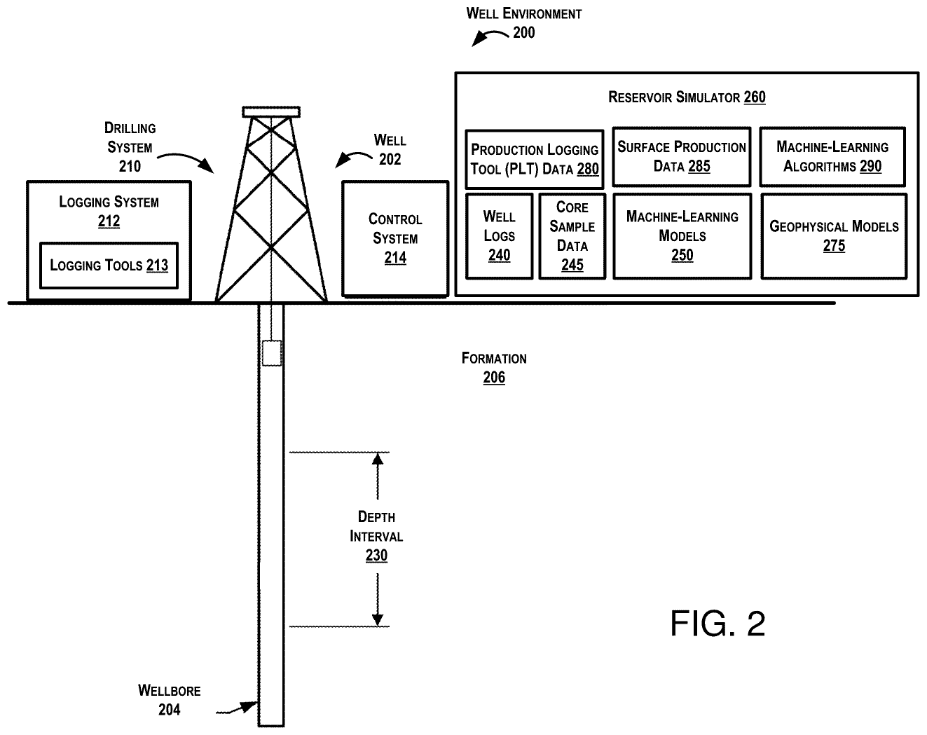

Turning to FIG. 2, FIG. 2 shows a schematic diagram in accordance with one or more embodiments. As shown, FIG. 2 illustrates a well environment (200) that may include a well (202) having a wellbore (204) extending into a formation (206). The wellbore (204) may include a bored hole that extends from the surface into a target zone of the formation (206), such as a reservoir. The formation (206) may include various formation characteristics of interest, such as formation porosity, formation permeability, resistivity, density, water saturation, and the like. Porosity may indicate how much space exists in a particular rock within an area of interest in the formation (206), where oil, gas, and/or water may be trapped. Permeability may indicate the ability of liquids and gases to flow through the rock within the area of interest. Resistivity may indicate how strongly rock and/or fluid within the formation (206) opposes the flow of electrical current. For example, resistivity may be indicative of the porosity of the formation (206) and the presence of hydrocarbons. More specifically, resistivity may be relatively low for a formation that has high porosity and a large amount of water, and resistivity may be relatively high for a formation that has low porosity or includes a large amount of hydrocarbons. Water saturation may indicate the fraction of water in a given pore space.

Keeping with FIG. 2, the well environment (200) may include reservoir simulator (260) and various well systems, such as a drilling system (210), a logging system (212), and a control system (214). The drilling system (210) may include a drill string, drill bit, a mud circulation system and/or the like for use in boring the wellbore (204) into the formation (206). Well systems may also include production systems that include production trees, production valves, downhole sensors, wellhead sensors, and the like. The control system (214) may include hardware and/or software for managing drilling operations or production operations. For example, the control system (214) may include one or more programmable logic controllers (PLCs) that include hardware and/or software with functionality to control one or more processes performed by the drilling system (210). A logging system may be similar to a control system with a specific focus on managing one or more logging tools.

Turning to the reservoir simulator (260), a reservoir simulator (260) may include hardware and/or software with functionality for storing and analyzing well logs (240), core sample data (245), PLT data (280), surface production data (285), cutting data, acoustic sensing data, seismic data, and/or other types of geophysical data to generate and/or update one or more geophysical models (275) and/or machine-learning models (250). Geophysical models may include geochemical or geomechanical models that describe structural relationships and/or geophysical properties (e.g., porosity, permeability, electrical resistivity, a particle velocity of medium, etc.) within a particular geological region. Likewise, a geophysical model may identify one or more rock types associated with one or more geological regions (e.g., formation (206)). Examples of rock types may include one or more depositional rock types (e.g., where a geological region is based on a depositional environment), rock types that include similar diagenetic processes, rock types based on similar geological trends, and/or rock types based on similar reservoir properties. For example, a rock type may correspond to an irreducible water saturation, residual oil saturations, rock permeability, capillary pressure, maximum capillary pressure heights, relative permeabilities, and rock classes.

The logging system (212) may include one or more logging tools (213) for use in generating well logs of the formation (206). For example, a logging tool may be lowered into the wellbore (204) to acquire measurements as the tool traverses a depth interval (230) (e.g., a targeted reservoir section) of the wellbore (204). The plot of the logging measurements versus depth may be referred to as a “log” or “well log”. Well logs (240) may provide depth measurements of the well (204) that describe such reservoir characteristics as formation porosity, formation permeability, resistivity, water saturation, and the like. The resulting logging measurements may be stored and/or processed, for example, by the control system (214), to generate corresponding well logs for the well (202). A well log (240) may include, for example, a plot of a logging response time versus true vertical depth (TVD) across the depth interval (230) of the wellbore (204).

Turning to examples of logging techniques, multiple types of logging techniques are available for determining various reservoir characteristics (e.g., wireline logging, logging-while-drilling (LWD), and measurement-while-drilling (MWD)). In some embodiments, gamma ray logging is used to measure naturally occurring gamma radiation to characterize rock or sediment regions within a wellbore. In particular, different types of rock may emit different amounts and different spectra of natural gamma radiation. For example, gamma ray logs may distinguish between shales and sandstones/carbonate rocks because radioactive potassium may be common to shales. Likewise, the cation exchange capacity of clay within shales may also result in higher absorption of uranium and thorium further increasing the amount of gamma radiation produced by shales.

Turning to nuclear magnetic resonance (NMR) logging, an NMR logging tool may measure the induced magnetic moment of hydrogen nuclei (i.e., protons) contained within the fluid-filled pore space of porous media (e.g., reservoir rocks). Thus, NMR logs may measure the magnetic response of fluids present in the pore spaces of the reservoir rocks. In so doing, NMR logs may measure both porosity and permeability, as well as the types of fluids present in the pore spaces. Thus, NMR logging may be a subcategory of electromagnetic logging that responds to the presence of hydrogen protons rather than a rock matrix. Because hydrogen protons may occur primarily in pore fluids, NMR logging may directly or indirectly measure the volume, composition, viscosity, and distribution of pore fluids.

Turning to spontaneous potential (SP) logging, SP logging may determine the permeabilities of rocks in the formation (206) by measuring the amount of electrical current generated between drilling fluid produced by the drilling system (210) and formation water that is held in pore spaces of the reservoir rock. Porous sandstones with high permeabilities may generate more electricity than impermeable shales. Thus, SP logs may be used to identify sandstones from shales.

Another type of electrical logging technique is resistivity logging. Resistivity logging may measure the electrical resistivity of rock or sediment in and around the wellbore (204). In particular, resistivity measurements may determine what types of fluids are present in the formation (206) by measuring how effective these rocks are at conducting electricity. Because fresh water and oil are poor conductors of electricity, they have high resistivities. As such, resistivity measurements obtained via such logging can be used to determine corresponding reservoir water saturation (S_{w}).

Another electrical logging technique is dielectric logging. For example, dielectric permittivity may be defined as a physical quantity that describes the propagation of an electromagnetic field through a dielectric medium. As such, dielectric permittivity may describe a physical medium's ability to polarize in response to an electromagnetic field, and thus reduce the total electric field inside the physical medium. In a portion of reservoir rock, water may have a large dielectric permittivity that is higher than any associated rock or hydrocarbon fluids within the portion. In particular, water permittivity may depend on a frequency of an electromagnetic wave, water pressure, water temperature, and salinity of the reservoir rock mixture. Likewise, a multi-frequency dielectric logging tool may determine a value of the water-filled porosity in the reservoir rock.

Keeping with dielectric logging, a dielectric logging tool may determine a dielectric constant (i.e., relative-permittivity) measurement. For example, the dielectric logging tool may include an antenna that detects relative dielectric constants between different fluids at a fluid interface. As such, a dielectric logging tool may generate a dielectric log of the high-frequency dielectric properties of a formation. In particular, a dielectric log may include two curves, where one curve may describe the relative dielectric permittivity of the analyzed rock and the other curve may describe the resistivity of the analyzed rock. Relative dielectric permittivity may be used to distinguish hydrocarbons from water of differing salinities. However, the effect of salinity may be more important than the salinity effect with a high-frequency dielectric log (also called an “electromagnetic propagation log”).

Turning to sonic logging or acoustic logging, the logging system (212) may measure the speed that acoustic waves travel through rocks in the formation (206) to determine porosity in the formation (206). This type of logging may generate borehole compensated (BHC) logs, which are also called sonic logs. In general, sound waves may travel faster through high-density shales than through lower-density sandstones. Other types of logging include density logging and neutron logging. Density logging may determine porosity measurements by directly measuring the density of the rocks in the formation (206). Furthermore, neutron logging may determine porosity measurements by assuming that the reservoir pore spaces within the formation (206) are filled with either water or oil and then measuring the amount of hydrogen atoms (i.e., neutrons) in the pores.

Turning to coring, reservoir characteristics may be determined using core sample data (e.g., core sample data (245)) acquired from a well site. For example, certain reservoir characteristics can be determined via coring (e.g., physical extraction of rock specimens) to produce core specimens and/or logging operations (e.g., wireline logging, logging-while-drilling (LWD) and measurement-while-drilling (MWD)). Coring operations may include physically extracting a rock specimen from a region of interest within the wellbore (204) for detailed laboratory analysis. For example, when drilling an oil or gas well, a coring bit may cut core plugs (or “cores” or “core specimens”) from the formation (206) and bring the core plugs to the surface, and these core specimens may be analyzed at the surface (e.g., in a lab) to determine various characteristics of the formation (206) at the location where the specimen was obtained.

Turning to various coring technique examples, conventional coring may include collecting a cylindrical specimen of rock from the wellbore (204) using a core bit, a core barrel, and a core catcher. The core bit may have a hole in its center that allows the core bit to drill around a central cylinder of rock. Subsequently, the resulting core specimen may be acquired by the core bit and disposed inside the core barrel. More specifically, the core barrel may include a special storage chamber within a coring tool for holding the core specimen. Furthermore, the core catcher may provide a grip to the bottom of a core and, as tension is applied to the drill string, the rock under the core breaks away from the undrilled formation below a coring tool. Thus, the core catcher may retain the core specimen to avoid the core specimen falling through the bottom of the drill string. In some embodiments, a micro computed tomography (micro-CT) scan is performed on a core sample. Several types of micro-CT scanning may be used, such as a desktop micro-CT scanner that uses an X-ray generation tube, and a synchrotron X-ray micro-tomography. In particular, a micro-CT scanner may use various X-rays to penetrate from different viewpoints in a core sample to produce an attenuated projection profile that is used for later reconstruction using a filtered back projection algorithm.

In some embodiments, cutting samples are acquired and analyzed from one or more drilling operations to determine various geological properties of one or more formations. In particular, cuttings may be initially cleaned in liquid detergent to remove drilling additives and before being dried on a ‘hotplate’. Dried cutting samples may be passed through one or more sieves to remove fragments of various sizes. Likewise, a magnet may be placed over a sieved cutting sample to remove any metallic fragments acquired during a drilling operation. After selecting various desired samples from the sieving and other preparation processes, selected samples may be ground into a fine powder for analysis using X-ray fluorescence (XRF) spectrometry processing and/or and inductively coupled plasma (ICP) spectrometry processing.

Turning to geosteering, geosteering may be used to position the drill bit or drill string of the drilling system (210) relative to a boundary between different subsurface layers (e.g., overlying, underlying, and lateral layers of a pay zone) during drilling operations. In particular, measuring rock properties during drilling may provide the drilling system (210) with the ability to steer the drill bit in the direction of desired hydrocarbon concentrations. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling. Likewise, a well path of a wellbore (204) may be updated by the control system (214) using a geophysical model (e.g., one of the geophysical models (275)). For example, a control system (214) may communicate geosteering commands to the drilling system (210) based on well data updates that are further adjusted by the reservoir simulator (260) using a geophysical model. As such, the control system (214) may generate one or more control signals for drilling equipment (or a logging system may generate for logging equipment) based on an updated well path design and/or a geophysical model.

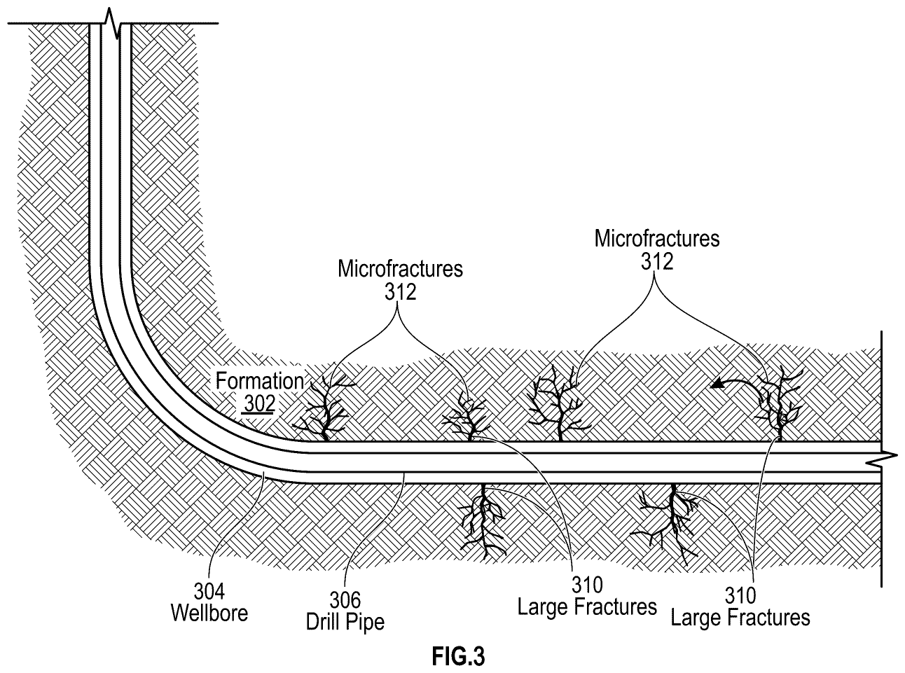

Turning to FIG. 3, FIG. 3 shows a schematic diagram in accordance with one or more embodiments. As shown in FIG. 3, FIG. 3 illustrates a hydraulic stimulation operation that forms additional microfractures (312) within a formation (302). More specifically, a wellbore (304) may be located within formation (302), where a casing string (306) is positioned within the wellbore (304). The wellbore (304) in FIG. 3 shows one example of a horizontal well. Following a hydraulic fracturing process, for example, large fractures (310) may exist within the formation (302) and extend outward from the wellbore (304). In particular, hydrocarbon reserves may be trapped within certain low permeability formations, such as sand, carbonate, and/or shale formations. Thus, stimulation treatments may be performed by a stimulation control system coupled to a well completion assembly or well completion system that enhances well productivity at one or more wells, where one type of stimulation treatment is hydraulic fracturing. In some embodiments, for example, hydraulic fracturing includes injecting high viscosity fluids into a wellbore at a sufficiently high injection rate so that enough pressure is produced within the wellbore to split the formation. As such, a stimulation operation may be determined that achieves a desired height and/or length of one or more induced fractures.

Keeping with FIG. 3, various stimulation procedures may be employed that use one or more techniques to ensure that an induced fracture becomes conductive after injection ceases. For example, during acid fracturing of carbonate formations, acid-based fluids may be injected into the formation to create an etched fracture and conductive channels. These conductive channels may be left open upon closure of the induced fracture. With sand or shale formations, a proppant may be included with the hydraulic fracturing fluid such that the induced fracture remains open during or following a stimulation treatment. Likewise, in carbonate formations, a stimulation treatment may include both acid fracturing fluids and proppants. Accordingly, heat produced within a formation, acid, or aqueous water transmitted into the formation may all play a role in producing reactions causing one or more microfractures in a formation.

Keeping with hydraulic fracturing, a hydraulic fracturing operation may include well completion assembly with one or more inflatable packers as well as a work string or casing string (306) that extends within a wellbore. A casing string may include steel casing or pipe that may be divided into surface casing, intermediate casing, and/or production casing. Packers may include inflatable packers that seal an annulus defined between well completion equipment and an inner wall of the wellbore in order to divide a formation into multiple wellbore intervals. These wellbore intervals may be separately or simultaneously stimulated during a hydraulic stimulation operation using a stimulation control system. Thus, in a hydraulic fracturing operation, a hydraulic fracturing fluid may be pumped through the casing string (306) and into a targeted formation using various perforations (i.e., open holes) in the casing string (306).

By injecting the hydraulic fracturing fluid at pressures high enough to cause the rock within the targeted formation to fracture, the hydraulic fracturing operation may “break down” the formation. As high-pressure fluid injection continues, a fracture may continue to propagate into a fracture network. This high pressure for injecting the hydraulic fracturing fluid may be referred to as the “propagation pressure” or “extension pressure.” As an induced fracture continues to grow, a proppant, such as sand, may be added to the fracturing fluid. Once a desired fracture network is formed, the fluid flow may be reversed, and the liquid portion of the fracturing fluid may be removed. The proppant is intentionally left behind to prevent the fractures from closing onto themselves due to the weight and stresses within the formation. Accordingly, the proppant may “prop” or support the induced fractures to remain open, by remaining sufficiently permeable for hydrocarbon fluids to flow through the induced fracture. Thus, a proppant may form a packed bed of particles with interstitial void space connectivity within a formation. Accordingly, a higher permeability fracture may result from the hydraulic fracturing operation.

In some embodiments, for example, a hydraulic fracturing fluid with an activator is injected into the formation (302), where the fluid migrates within the large fractures (310). Upon a reaction caused by the activator, the injection fluid may produce one or more gases and heat, thereby causing the microfractures (312) to be created within the formation (302). Thus, a stimulation treatment may provide pathways for the hydrocarbon deposits trapped within the formation (302) to migrate and be recovered by a production well. In other words, hydraulic stimulation operations may be applied to formations that easily fracture to produce more microfractures with little plastic deformation under compression.

Furthermore, fracture monitoring may be important to understanding and optimizing hydraulic fracturing treatments. For example, a hydraulic stimulation manager may perform diagnostics that determine various stimulation effects such as fracture geometry, proppant placement in one or more fractures, and/or fracture conductivity. This fracture monitoring may be performed using a distributed acoustic sensing (DAS) system implemented within a wellbore. In some embodiments, a DAS system includes various fiber-optic sensors (e.g., distributed over a single mode optical fiber several kilometers in length). As such, backscattered light may be measured and further analyzed using signal processing techniques to enable a DAS system to segregate an optical fiber into an array of individual acoustic receivers. More specifically, various pulses of light may be transmitted along the optical fiber, where characteristics of the backscattered light may change due to acoustic vibrations disturbing the casing of the optical fiber. Through DAS processing, the location of these disturbances may be identified.

Keeping with DAS systems, pumping operations may produce various acoustic signals along a wellbore and the adjacent fractures, where the acoustic sensing data depends upon geometrical and physical attributes of the propagating fractures. Accordingly, a quantitative DAS inversion may determine various fracture properties in hydraulic fracture monitoring. For example, a wellbore may be profiled in real time by removing DAS pump noise data and matching acquired data to a forward model regarding pulse propagation in the wellbore and adjacent fractures. Thus, DAS inversion may identify various hydraulic stimulation features such as tubing expansion, fluid-to-fluid interfaces, an adjacent hydraulic fracture, presence of a porous reservoir, and/or an annular compartment. During initial phases of a hydraulic stimulation operation, DAS inversion may determine location information of wireline logging equipment within a wellbore. For example, DAS techniques may verify whether perforating guns and packer-setting devices are disposed at desired depths in the wellbore. In some embodiments, DAS inversion is performed using additional data from distributed temperature sensors (DTS) and/or micro-seismic monitoring techniques.

In certain unconventional formations, for example, an important element that determines whether hydrocarbon recovery is economically viable is the presence of one or more sweet spots in the reservoir. A sweet spot may be generally defined herein as the area within a reservoir that represents the best production or potential for production. In a particular geological region, the sweet spot may be determined based on a lack of ductility, a destruction of internal cohesion, an ability for a rock to deform and fail with a low degree of inelastic behavior, and a rock's capability for self-sustaining fracturing. Likewise, sweet spots may include intervals within organic shales, which possess the highest relative hydrocarbon yield for drilling purposes.

Keeping with sweet spots, sweet spot identification may be used by a reservoir simulator to identify one or more drilling location for unconventional wells. In particular, a sweet spot may be determined with certain reservoir characteristics such as reservoir quality and completion quality based on predicted hydrocarbon data, reservoir data, well log data, seismic data, etc. As such, various technologies may be used to extract resources from unconventional reservoirs at certain sweet spots, such as hydraulic fracturing and horizontal wells.

With respect to proppant systems, a well completion system may include a proppant system. A proppant system may include transfer devices, such as chutes and conveyor belts, for transferring a propping agent (also called simply “proppant”) to a fluid mixing system. Likewise, a proppant system may include one or more proppant storage devices, such as a silo, and a housing. In particular, a silo may use fill ports for acquiring propping agents, which may be subsequently transferred to a fluid mixing system using drain valves and/or outlet ports. The proppant system may then dispense the propping agent to the fluid mixing system for producing a stimulation fluid.

Moreover, a stimulation treatment for a formation may be updated by a reservoir simulator using a geophysical model. For example, a reservoir simulator may use a geophysical model to perform one or more stimulation simulations using different injection fluid pressure rates, different types of proppants, acid-based treatments and non-acid treatments, etc., to determine a desired stimulation scenario for the formation.

Returning to FIG. 2, a reservoir simulator (e.g., reservoir simulator (260)) may include hardware and/or software with functionality for generating and/or updating one or more machine-learning models (e.g., machine-learning models (250)) to determine predicted flow rate data and/or various flow parameters at different depth intervals in a wellbore. Examples of machine-learning models may include random forest models and artificial neural networks, such as convolutional neural networks, deep neural networks, and recurrent neural networks. Machine-learning (ML) models may also include support vector machines (SVMs), Naïve Bayes models, ridge classifier models, gradient boosting models, decision trees, inductive learning models, deductive learning models, supervised learning models, unsupervised learning models, reinforcement learning models, and the like. In a deep neural network, for example, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network. In some embodiments, two or more different types of machine-learning models are integrated into a single machine-learning architecture, e.g., a machine-learning model may include a random forest model and various neural networks. In some embodiments, a reservoir simulator may generate augmented data or synthetic data to produce a large amount of interpreted data for training a particular model.

In some embodiments, various types of machine-learning algorithms (e.g., machine-learning algorithm (290)) may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning model.

In some embodiments, a machine-learning model is trained using multiple epochs. For example, an epoch may be an iteration of a model through a portion or all of a training dataset. As such, a single machine-learning epoch may correspond to a specific batch of training data, where the training data is divided into multiple batches for multiple epochs. Thus, a machine-learning model may be trained iteratively using epochs until the model achieves a predetermined criterion, such as predetermined level of prediction accuracy or training over a specific number of machine-learning epochs or iterations. Thus, better training of a model may lead to better predictions by a trained model.

With respect to artificial neural networks, for example, an artificial neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the artificial neural network. Likewise, these weighted data inputs may be summed such that this sum is communicated through a neuron's activation function to other hidden layers within the artificial neural network. As such, the activation function may determine whether and to what extent an output of a neuron progresses to other neurons where the output may be weighted again for use as an input to the next hidden layer.

Turning to recurrent neural networks, a recurrent neural network (RNN) may perform a particular task repeatedly for multiple data elements in an input sequence (e.g., a sequence of temperature values or flow rate values), with the output of the recurrent neural network being dependent on past computations. As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells. Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps. To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, a reservoir simulator uses one or more ensemble learning methods to produce a hybrid-model architecture. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions.

Turning to random forests, a random forest model may an algorithmic model that combines the output of multiple decision trees to reach a single predicted result. For example, a random forest model may be composed of a collection of decision trees, where training the random forest model may be based on three main hyperparameters that include node size, a number of decision trees, and a number of input features being sampled. During training, a random forest model may allow different decision trees to randomly sample from a dataset with replacement (e.g., from a bootstrap sample) to produce multiple final decision trees in the trained model. For example, when multiple decision trees form an ensemble in the random forest model, this ensemble may determine more accurate predicted data, particularly when the individual trees are uncorrelated with each other. In some embodiments, a random forest model implements a software algorithm that is an extension of a bagging method. As, a random forest model may use both bagging and feature randomness to create an uncorrelated forest of decision trees. Feature randomness (also referred to as “feature bagging”) may generate a random subset of input features. This random subject may thereby result in low correlation among decision trees in the random forest model. In a training operation for a random forest model, a training operation may search for decision trees that provide the best split to subset particular data, such as through a Classification and Regression Tree (CART) algorithm. Different metrics, such as information gain or mean square error (MSE), may be used to determine the quality of a data split for various decision trees.

Keeping with random forests, a random forest model may be a classifier that uses data having discrete labels or classes. Likewise, a random forest model may also be used as a random forest regressor to solve regression problems. Depending on the type of problem being addressed by the random forest model, how predicted data is determined may vary accordingly. For a regression task, the individual decision trees may be averaged in a predicted result. For a classification task, a majority vote (e.g., predicting an output based on the most frequent categorical variable) may determine a predicted class. In a random forest regressor, the model may work with data having a numeric or continuous output, which cannot be defined by distinct classes.

While the reservoir simulator (260) is shown at a well site in FIG. 2, in some embodiments, the reservoir simulator (260) or other components in FIG. 2 may be remote from a well site. In some embodiments, the reservoir simulator (260) is implemented as part of a software platform for the control system (214) in FIG. 2. The software platform may obtain data acquired by the drilling system (210) and the logging system (212) as inputs, which may include multiple data types from multiple sources. The software platform may aggregate the data from these systems (210, 212, 214) in real time for rapid analysis. In some embodiments, the control system (214), the logging system (212), the reservoir simulator (260), and/or a user device coupled to one of these systems may include a computer system that is similar to the computer system (1502) described below with regard to FIG. 15 and the accompanying description.

While FIGS. 1, 2, and 3 show various configurations of components, other configurations may be used without departing from the scope of the disclosure. For example, various components in FIGS. 1, 2, and 3 may be combined to create a single component. As another example, the functionality performed by a single component may be performed by two or more components.

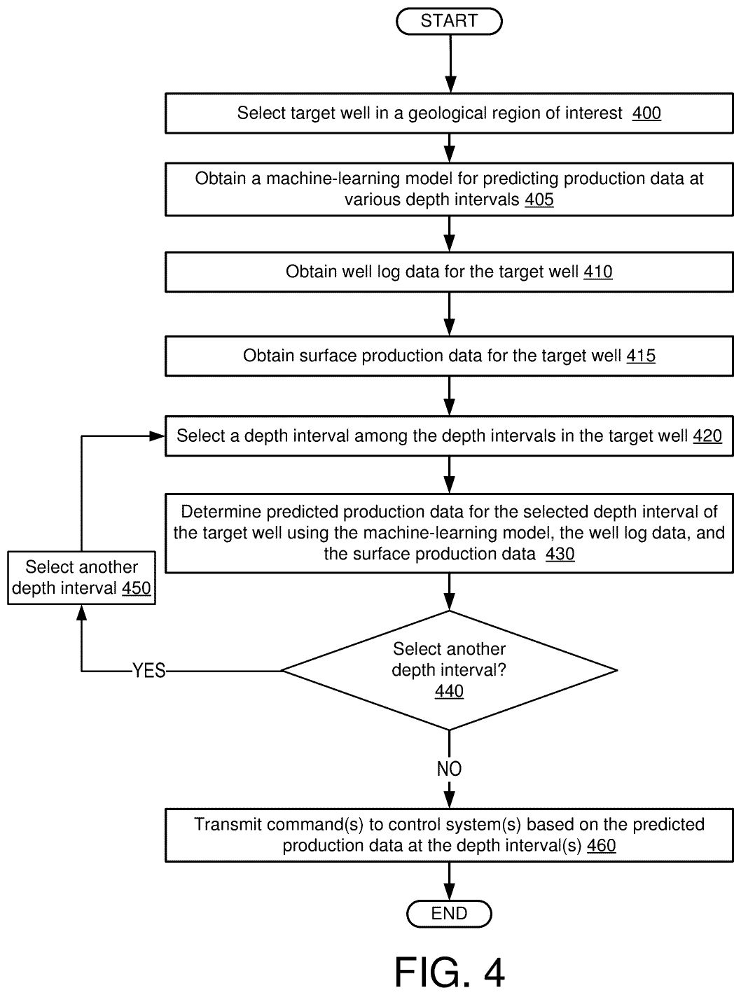

Turning to FIG. 4, FIG. 4 shows a flowchart in accordance with one or more embodiments. Specifically, FIG. 4 describes a general method for predicting production data at different depth intervals using machine learning. One or more blocks in FIG. 4 may be performed by one or more components (e.g., reservoir simulator (160)) as described in FIGS. 1, 2, and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, a target well is selected in a geological region of interest in accordance with one or more embodiments. A geological region of interest may be a portion of a geological area or volume that includes a reservoir region, one or more wells, and/or one or more formations of interest desired or selected for further analysis. Likewise, the target well may be a particular well desired or selected for analyzing production data at different intervals within the well. For example, the target well may be a production well being analyzed for any future water breakthroughs.

In Block 405, a machine-learning model is obtained for predicting production data at various depth intervals in accordance with one or more embodiments. For example, the machine-learning model may be similar to one or more machine-learning models described in FIG. 1 and the accompanying description. In some embodiments, for example, the machine-learning model is a trained random forest model that predicts production data at various depth intervals.

In Block 410, well log data are obtained for a target well in accordance with one or more embodiments. For example, well log data may be acquired for a target well when the wellbore is first drilled. In horizontal wells, well log data may be acquired using coiled-tubing units rather than wirelines techniques. Well log data may provide calculated information such as oil and water saturations, porosity, permeability, and formation lithology. Well log data may be stored in tables in association with a particular depth. Geological or reservoir characteristics at the particular depth may be referred to as features that may be input to a machine-learning model. Well log data may be acquired in a similar manner as described in FIG. 2 and the accompanying description. In some embodiments, other types of geophysical data are contemplated in addition or in place of well log data, such as core sample data, seismic data, and cutting data.

In Block 415, surface production data are obtained for a target well in accordance with one or more embodiments. After a well begins a production operation extracting hydrocarbons from the subsurface, surface production data may be collected regarding the target well. For example, a reservoir simulator or other control system may obtain surface production data and monitor the surface production data at a frequency dependent on well operation requirements (e.g., a well operator may have desired amounts of oil and gas production at the well). In some embodiments, surface production data may include various production rates, such as a gas rate, an oil rate, and a water rate within the well's production. Surface production data may include a once-in-a-lifetime measurement of production values to real-time data acquisition of surface production data. Surface production data may also include related values, such as oil-gas ratios, water-gas ratios, wellhead pressure and temperature data, etc. In some embodiments, surface production data is obtained by a surface sensing system similar to the surface sensing system (134) shown in FIG. 1 and the accompanying description.

In Block 420, a depth interval among various depth intervals is selected in a target well in accordance with one or more embodiments. For example, a reservoir simulator may iteratively analyze production data at different depths in a wellbore, such as to determine which specific depth interval may be experiencing a water breakthrough.

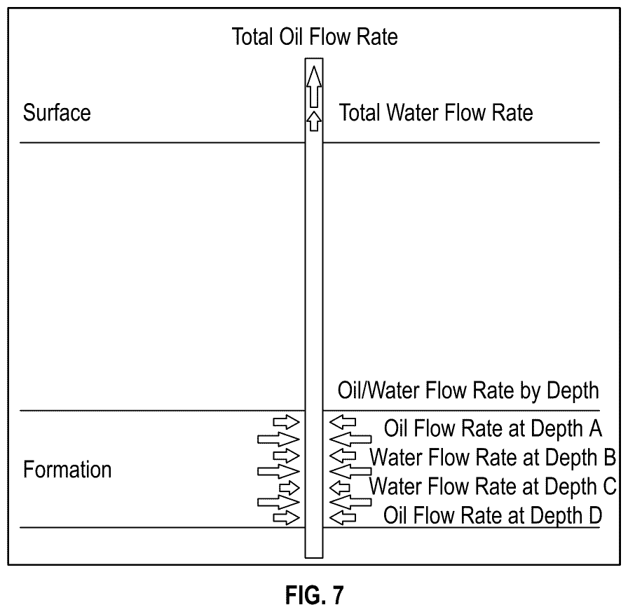

In Block 430, predicted production data are determined for a selected depth interval of a target well using a machine-learning model, well log data, and surface production data in accordance with one or more embodiments. In some embodiments, for example, prediction production data includes predicted water flow intervals that are determined using various extracted input features input to one or more machine-learning models. In some embodiments, input features include both continuous reservoir variables such as, porosity values and permeability values of a formation's rock matrix or a particular fracture, as well as categorical variables. Examples of categorical variables may include one or more specific petrophysical rock types or a particular water cut from a water rate test. In particular, a water cut value from a rate test may be treated as a categorical variable such that when a water cut value showing more than zero may correspond to a “1” value, while a rate test with no water may correspond to a “0” value. Thus, a categorical variable may be used to determine the presence or absence of a water cut value, or another value used as an input feature to a machine-learning model. In FIG. 7, FIG. 7 illustrates an example wellbore for a production operation illustrating different between production rates at different depth intervals that contribute to a combined surface production rate.

In some embodiments, a target variable for predicted production data is a prediction of water entry at a particular depth interval. For example, water entry may be a predicted categorical variable that corresponds to a specific depth interval in a wellbore. Where the depth interval of the target well has production with no water and only flowing oil, the predicted water entry value may be identified as “0” or false.

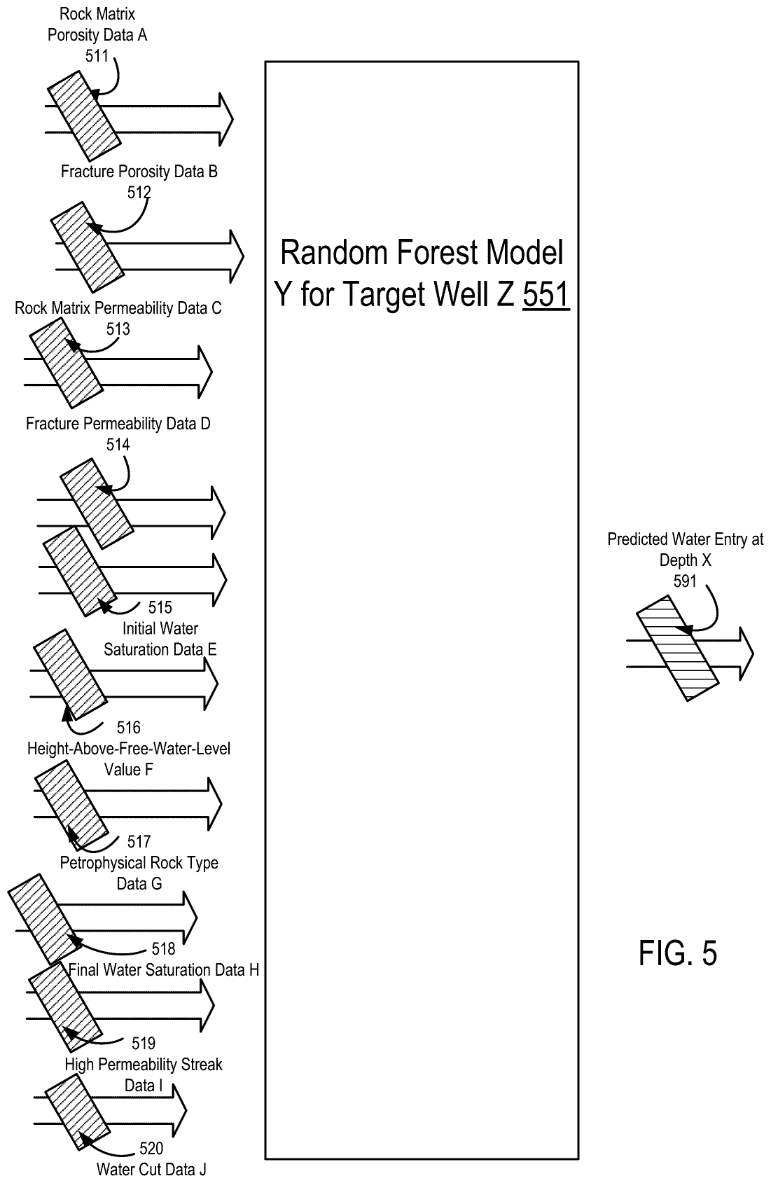

Turning to FIG. 5, FIG. 5 provides an example of a random forest model for predicting water production flow at different depth intervals in accordance with one or more embodiments. The following example is for explanatory purposes only and not intended to limit the scope of the disclosed technology. In FIG. 5, a random forest model Y (551) for target well Z determines a predicted water entry (591) at depth X in the target well Z during a production operation. More specifically, the random forest model Y (551) obtains the following inputs, i.e., rock matrix data A (511), fracture porosity data B (512), rock matrix permeability data C (513), fracture permeability data D (514), initial water saturation data E (515), height-above-free-water-level value F (516), petrophysical rock type data G (517), final water saturation data H (518), high permeability streak data I (519), and water cut data J (520). The random forest model Y (551) may be trained using a machine-learning algorithm, such as a supervised learning algorithm.

Returning to FIG. 4, in Block 440, a determination is made whether to select another depth interval in accordance with one or more embodiments. For example, a reservoir simulator may predict production data for each depth interval corresponding to one or more particular formations in a geological region, or for all depth intervals in an entire wellbore. For example, a reservoir simulator or control system may evaluate the status of different intervals in a well in order to maintain or adjust production operations. In particular, the process may also continue until a water breakthrough or other production issue is predicted for one or more of the depth intervals. If another depth interval of interest is desired for analysis, the process may proceed to Block 450. If no more depth intervals of interest exist, the process may proceed to Block 460.

In Block 450, another depth interval is selected in accordance with one or more embodiments.

In Block 460, one or more commands are transmitted to one or more control systems based on predicted production data at one or more depth intervals in accordance with one or more embodiments. Furthermore, commands, such as control signals, may be transmitted over a network connecting multiple well sites to adjust production parameters (e.g., surface flow rate, wellhead temperature, wellhead pressure, etc.). For example, commands may adjust production settings at various wells or include shut-off commands for terminating production operations. Commands may also be used to initiate or increase production operations at a specific well based on predicted production data at different depth intervals for other wells. In some embodiments, commands are used to trigger one or more stimulation operations, such as in response to a drop in hydrocarbon production or the presence of a water breakthrough at a target well.

In some embodiments, for example, one or more control systems may control water shut off operations at the target well based on the predicted production data. By controlling water production at different depth intervals, the life of a target well may be extended to continue commercially viable hydrocarbon production. Furthermore, some commands may be used to initiate and/or manage one or more remediation operations for addressing water breakthrough. For example, a remediation operation may include mechanical and chemical well intervention operations that use chemical packers, foam gel, a dual completion, and inflow control devices to control water entering particular depth intervals.

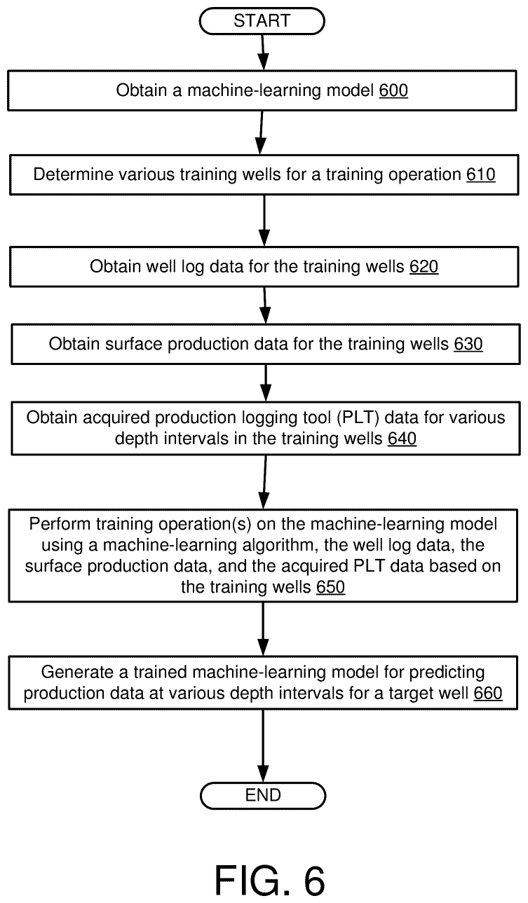

Turning to FIG. 6, FIG. 6 shows a flowchart in accordance with one or more embodiments. Specifically, FIG. 6 describes a general method for training a machine-learning model to predict production data at different depth intervals. One or more blocks in FIG. 6 may be performed by one or more components (e.g., reservoir simulator (160)) as described in FIGS. 1, 2, and 3. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, a machine-learning model is obtained in accordance with one or more embodiments. For example, the machine-learning model may be similar to one or more machine-learning models described in FIG. 1 and the accompanying description.

In Block 610, various training wells are determined for a training operation in accordance with one or more embodiments. For example, training wells may include production wells in the same reservoir region or a similar reservoir region as the target well selected for predicting production data at different depth intervals.

In Block 620, well log data are obtained for various training wells in accordance with one or more embodiments. Well log data may be similar to the well log data described above in FIG. 2 and Block 410 in FIG. 4 and the accompanying description.

In Block 630, surface production data are obtained for various training wells in accordance with one or more embodiments. Surface production data may be similar to the surface production data described in FIGS. 1 and 2 and Block 415 in FIG. 4 and the accompanying description.

In Block 640, acquired production logging tool (PLT) data are obtained for various depth intervals in various training wells in accordance with one or more embodiments.

In Block 650, one or more training operations are performed on a machine-learning model using a machine-learning algorithm, well log data, surface production data, and acquired PLT data based on various training wells in accordance with one or more embodiments. In order to develop a machine-learning model, a dataset may be used to train or retrain model. This training dataset may include various input features at specified depths, acquired target variables for the depths and other acquired PLT data (e.g., oil and water rates at different depth intervals acquired using production logging tools), and surface production data at the time of conducting the PLT operations. Likewise, the training operation may include one or more machine-learning epochs as described above in FIG. 2 and the accompanying description.

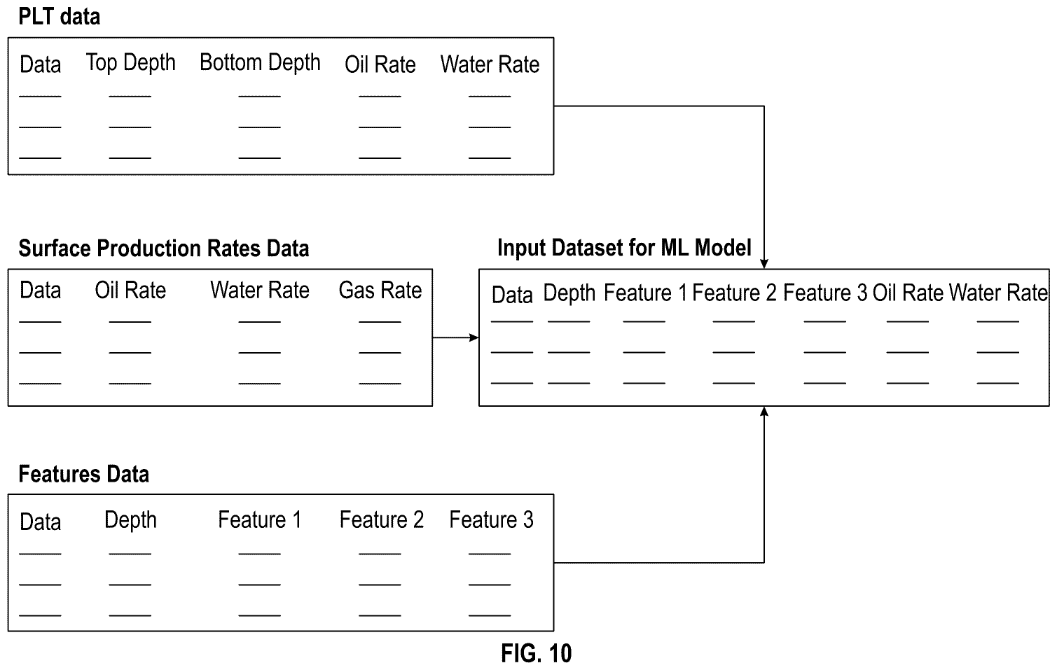

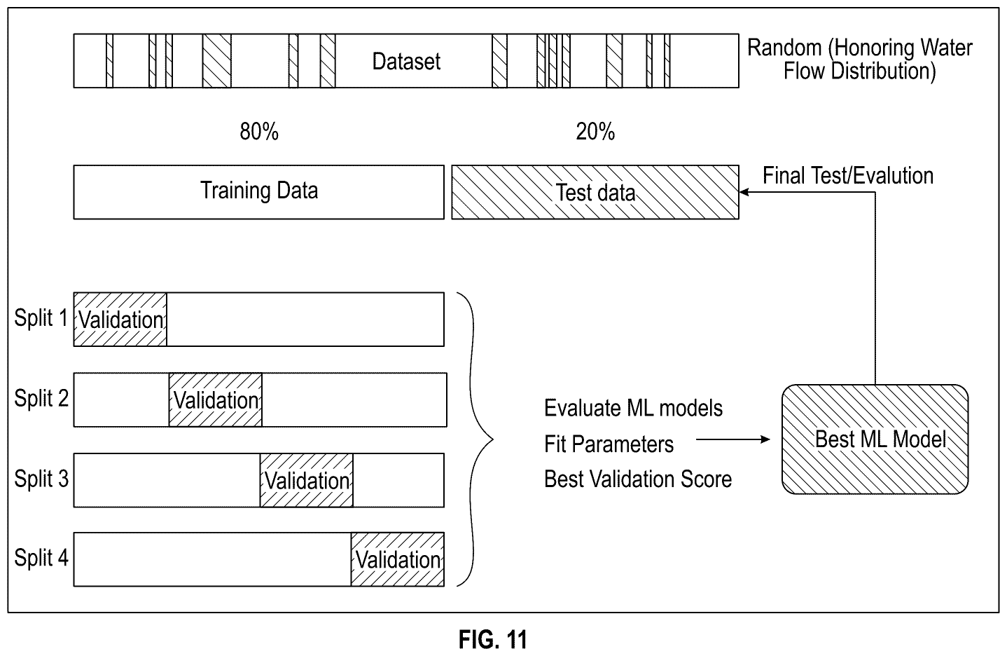

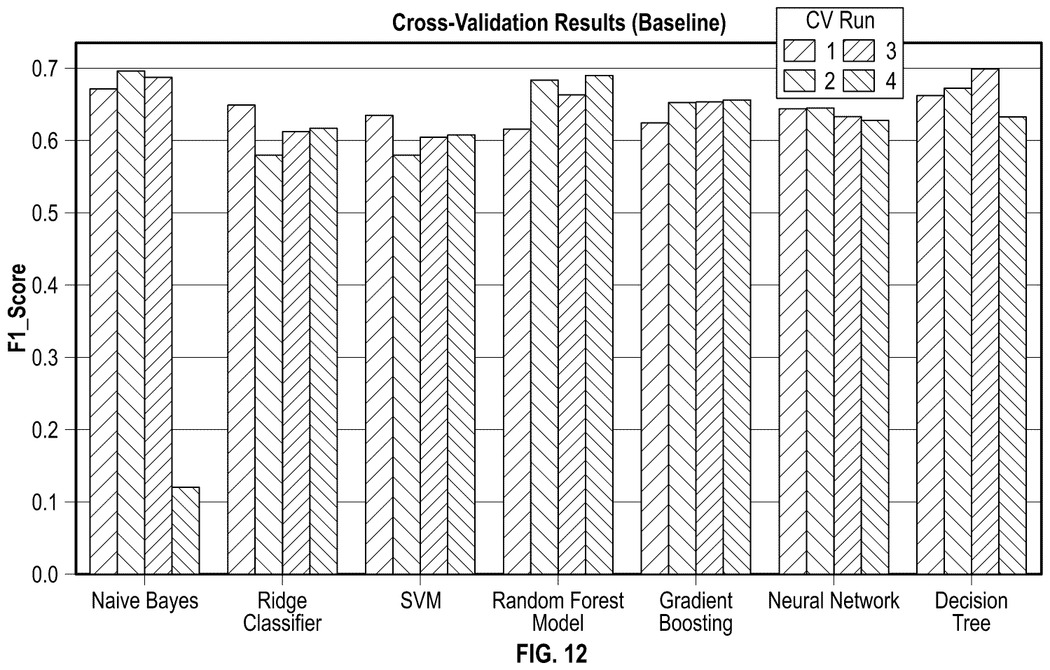

Turning to FIGS. 10 and 11, FIG. 10 illustrates an example training data template for a training operation data for a machine-learning model. In FIG. 10, a PLT table includes data that should be predicted by the machine-learning model after training. Once the machine-learning model is trained, for example, the trained model may be used to determine predicted PLT data based on various input features, such as initial well log data (e.g., well log data for the target well when the well was initially drilled) and surface production data. Moreover, FIG. 11 shows an example machine-learning workflow for training a particular model. As shown in FIG. 11, various selection techniques may be used to train and evaluate a prepared training and testing dataset. As such, the dataset may be randomly divided to include data batches corresponding to 80% training and 20% testing. In FIG. 11, the prepared training data is designed to match various water flow distributions to prevent imbalanced data. Several types of machine learning models may be trained accordingly using this example workflow using cross validation techniques to prevent under/overfitting problems during data prediction. For example, various evaluation metrics may be used to analyze a trained model, such as a combination between precision and recall (e.g., the F1_Score metric that is shown in the y-axis of FIG. 12).

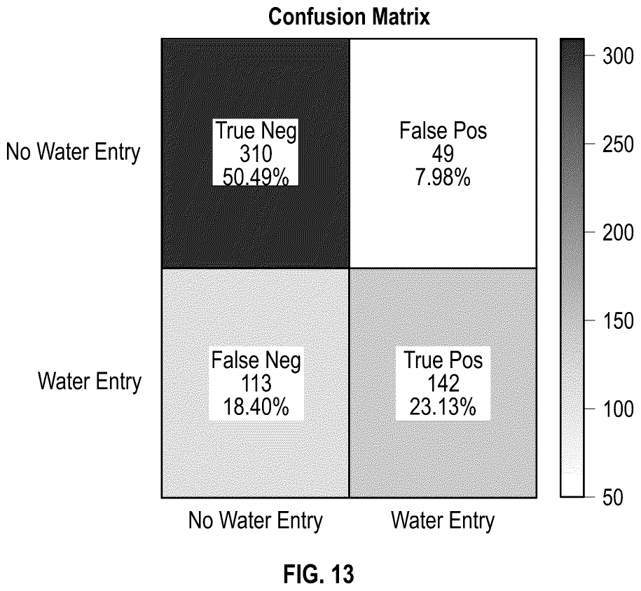

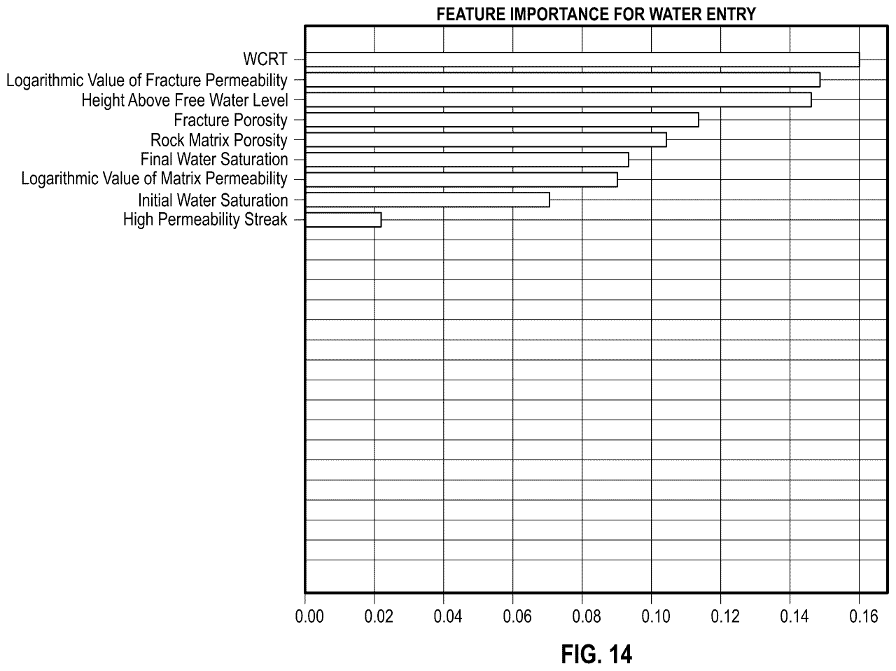

Turning to FIGS. 12, 13, and 14, FIG. 12 illustrates various cross-validation results of various machine learning models evaluated using a particular training dataset. More specifically, FIG. 12 shows a random forest model that provided the best score based on an evaluation metric as compared to other machine-learning models. The random forest model was then used to predict data for various unseen test samples. Moreover, FIG. 13 shows confusion matrix results that are generated for various unseen water flow samples which illustrate a balanced accuracy score of 71% of both labels for water entry and no water entry. Thus, features importance analysis for the random forest model may indicate that water cut data, fracture permeability data, height-above-free-water level data, and fracture porosity data may be important input features in predicting water flow at different intervals across a well. Likewise, FIG. 14 shows this features importance analysis of a random forest model based on test sample predictions.

Returning to FIG. 6, in Block 660, a trained machine-learning model is generated for predicting production data at various depth intervals for a target well in accordance with one or more embodiments.

Embodiments may be implemented on a computer system. FIG. 15 is a block diagram of a computer system (1502) used to provide computational functionalities associated with described algorithms, methods, functions, processes, flows, and procedures as described in the instant disclosure, according to an implementation. The illustrated computer (1502) is intended to encompass any computing device such as a high performance computing (HPC) device, server, desktop computer, laptop/notebook computer, wireless data port, smart phone, personal data assistant (PDA), tablet computing device, one or more computer processors within these devices, or any other suitable processing device, including both physical or virtual instances (or both) of the computing device. Additionally, the computer (1502) may include a computer that includes an input device, such as a keypad, keyboard, touch screen, or other device that can accept user information, and an output device that conveys information associated with the operation of the computer (1502), including digital data, visual, or audio information (or a combination of information), or a GUI.

The computer (1502) can serve in a role as a client, network component, a server, a database or other persistency, or any other component (or a combination of roles) of a computer system for performing the subject matter described in the instant disclosure. The illustrated computer (1502) is communicably coupled with a network (1530). In some implementations, one or more components of the computer (1502) may be configured to operate within environments, including cloud-computing-based, local, global, or other environment (or a combination of environments).

At a high level, the computer (1502) is an electronic computing device operable to receive, transmit, process, store, or manage data and information associated with the described subject matter. According to some implementations, the computer (1502) may also include or be communicably coupled with an application server, e-mail server, web server, caching server, streaming data server, business intelligence (BI) server, or other server (or a combination of servers).

The computer (1502) can receive requests over network (1530) from a client application (for example, executing on another computer (1502)) and responding to the received requests by processing the said requests in an appropriate software application. In addition, requests may also be sent to the computer (1502) from internal users (for example, from a command console or by other appropriate access method), external or third-parties, other automated applications, as well as any other appropriate entities, individuals, systems, or computers.

Each of the components of the computer (1502) can communicate using a system bus (1503). In some implementations, any or all of the components of the computer (1502), both hardware or software (or a combination of hardware and software), may interface with each other or the interface (1504) (or a combination of both) over the system bus (1503) using an application programming interface (API) (1512) or a service layer (1513) (or a combination of the API (1512) and service layer (1513). The API (1512) may include specifications for routines, data structures, and object classes. The API (1512) may be either computer-language independent or dependent and refer to a complete interface, a single function, or even a set of APIs. The service layer (1513) provides software services to the computer (1502) or other components (whether or not illustrated) that are communicably coupled to the computer (1502). The functionality of the computer (1502) may be accessible for all service consumers using this service layer. Software services, such as those provided by the service layer (1513), provide reusable, defined business functionalities through a defined interface. For example, the interface may be software written in JAVA, C++, or other suitable language providing data in extensible markup language (XML) format or other suitable format. While illustrated as an integrated component of the computer (1502), alternative implementations may illustrate the API (1512) or the service layer (1513) as stand-alone components in relation to other components of the computer (1502) or other components (whether or not illustrated) that are communicably coupled to the computer (1502). Moreover, any or all parts of the API (1512) or the service layer (1513) may be implemented as child or sub-modules of another software module, enterprise application, or hardware module without departing from the scope of this disclosure.

The computer (1502) includes an interface (1504). Although illustrated as a single interface (1504) in FIG. 15, two or more interfaces (1504) may be used according to particular needs, desires, or particular implementations of the computer (1502). The interface (1504) is used by the computer (1502) for communicating with other systems in a distributed environment that are connected to the network (1530). Generally, the interface (1504 includes logic encoded in software or hardware (or a combination of software and hardware) and operable to communicate with the network (1530). More specifically, the interface (1504) may include software supporting one or more communication protocols associated with communications such that the network (1530) or interface's hardware is operable to communicate physical signals within and outside of the illustrated computer (1502).

The computer (1502) includes at least one computer processor (1505). Although illustrated as a single processor (1505) in FIG. 15, two or more computer processors may be used according to particular needs, desires, or particular implementations of the computer (1502). Generally, the computer processor (1505) executes instructions and manipulates data to perform the operations of the computer (1502) and any algorithms, methods, functions, processes, flows, and procedures as described in the instant disclosure.

The computer (1502) also includes a memory (1506) that holds data for the computer (1502) or other components (or a combination of both) that can be connected to the network (1530). For example, memory (1506) can be a database storing data consistent with this disclosure. Although illustrated as a single memory (1506) in FIG. 15, two or more memories may be used according to particular needs, desires, or particular implementations of the computer (1502) and the described functionality. While memory (1506) is illustrated as an integral component of the computer (1502), in alternative implementations, memory (1506) can be external to the computer (1502).

The application (1507) is an algorithmic software engine providing functionality according to particular needs, desires, or particular implementations of the computer (1502), particularly with respect to functionality described in this disclosure. For example, application (1507) can serve as one or more components, modules, applications, etc. Further, although illustrated as a single application (1507), the application (1507) may be implemented as multiple applications (1507) on the computer (1502). In addition, although illustrated as integral to the computer (1502), in alternative implementations, the application (1507) can be external to the computer (1502).

There may be any number of computers (1502) associated with, or external to, a computer system containing computer (1502), each computer (1502) communicating over network (1530). Further, the term “client,” “user,” and other appropriate terminology may be used interchangeably as appropriate without departing from the scope of this disclosure. Moreover, this disclosure contemplates that many users may use one computer (1502), or that one user may use multiple computers (1502).

In some embodiments, the computer (1502) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining first well log data for a first well;
obtaining first surface production data for the first well based on a production operation, wherein the first well log data is acquired at the first well prior to the production operation being performed at the first well;
obtaining a selection of a first depth interval among a plurality of depth intervals in the first well;
determining, by a computer processor, first predicted production data for the first depth interval in the first well using a first machine-learning model, the selection of the first depth interval, the first well log data, and the first surface production data; and
transmitting, by the computer processor, a first command to a first control system at the first well based on the first predicted production data.

2. The method of claim 1, further comprising:
determining second predicted production data for a second depth interval among the plurality of depth intervals;
determining whether the second depth interval is experiencing a water breakthrough based on the second predicted production data; and
transmitting a second command to a second control system,
wherein the second command implements a remediation operation in response to determining that the second depth interval is experiencing the water breakthrough.

3. The method of claim 1, further comprising:
determining, using the first well log data, rock matrix porosity data, and fracture porosity data for the first depth interval in the first well;
determining, using the first well log data, rock matrix permeability data, and fracture permeability data for the first depth interval in the first well; and
determining a petrophysical rock type for the first depth interval,
wherein the rock matrix porosity data, the fracture porosity data, the rock matrix permeability data, the fracture permeability data, and the petrophysical rock type are used by the first machine-learning model to determine the first predicted production data for the first depth interval.

4. The method of claim 1, further comprising:
determining a height value above free water level of the first depth interval;
determining first water saturation data of the first depth interval prior to the production operation;
determining second water saturation data for the first depth interval during the production operation; and
determining, using a water cut sensor, water cut data during the production operation,
wherein the height value, the first water saturation data, the second water saturation data, and the water cut data are used by the first machine-learning model to determine the first predicted production data for the first depth interval.

5. The method of claim 1,
wherein the first predicted production data corresponds to a water entry at the first depth interval in the first well.

6. The method of claim 1,
wherein the first surface production data comprise oil rate data, water rate data, and total flow rate data, and
wherein the first surface production data are acquired using a multiphase flow meter.

7. The method of claim 1,
wherein the first machine-learning model is a random forest model comprising a plurality of decision tree nodes coupled using an ensemble method, and
wherein the first machine-learning model is trained using a bootstrap and aggregation operation.

8. The method of claim 1, further comprising:
obtaining a selection of a second depth interval and a third depth interval among the plurality of depth intervals in the first well, wherein the second depth interval is higher in the first well than the third depth interval;
determining, using the first machine-learning model, the first well log data, and second surface production data, first predicted oil rate data at the second depth interval; and
determining, using the first machine-learning model, the first well log data, and the second surface production data, second predicted oil rate data at the third depth interval,
wherein the first predicted oil rate data is greater than the second predicted oil rate data.

9. The method of claim 1, further comprising:
obtaining training data comprising second well log data for a plurality of training wells, second surface production data for the plurality of training wells, and acquired production logging tool (PLT) data for a second plurality of depth intervals for the plurality of training wells,
wherein the acquired PLT data is acquired using a plurality of production logging tools in the plurality of training wells; and
performing a training operation of an initial model using the training data to produce the first machine-learning model.

10. The method of claim 1, further comprising:
acquiring, using a logging system coupled to the first well, the first well log data.

11. The method of claim 1,
wherein the first control system is coupled to a wellhead assembly, and
wherein the first command adjusts one or more production parameters in the wellhead assembly.

12. A method, comprising:
obtaining a first machine-learning model;
obtaining well log data for a plurality of wells;
obtaining surface production data for the plurality of wells;
obtaining acquired production logging tool (PLT) data for a plurality of depth intervals in the plurality of wells; and
generating, by a computer processor, a trained machine-learning model using the first machine-learning model, the well log data, the surface production data, and the acquired PLT data,
wherein the trained machine-learning model is configured to determine first predicted production data for a predetermined depth interval in a first well, and
wherein the first machine-learning model is updated iteratively during a plurality of machine-learning epochs based on a comparison between a portion of the acquired PLT data and second predicted production data that are generated by the first machine-learning model in a respective machine-learning epoch among the plurality of machine-learning epochs.

13. The method of claim 12, further comprising:
determining, using the well log data, rock matrix porosity data, rock matrix permeability data, petrophysical rock type data, fracture porosity data, and fracture permeability data for the plurality of wells; and
determining a training dataset comprising the rock matrix porosity data, the rock matrix permeability data, the petrophysical rock type data, the fracture permeability data, and the fracture permeability data,
wherein the training dataset is separated into a plurality of batches for the plurality of machine-learning epochs.

14. The method of claim 12,
wherein the trained machine-learning model is a random forest model comprising a plurality of decision tree nodes coupled using an ensemble method, and
wherein the trained machine-learning model is trained using a bootstrap and aggregation operation.

15. The method of claim 12,
wherein the first predicted production data corresponds to a categorical variable based on whether the predetermined depth interval is experiencing a water breakthrough.

16. A system, comprising:
a first well control system coupled to a first well; and
a reservoir simulator comprising a computer processor, wherein the reservoir simulator is coupled to the first well control system, the reservoir simulator being configured to perform a method comprising:
obtaining first well log data for the first well;
obtaining first surface production data for the first well based on a production operation at the first well, wherein the first well log data is acquired at the first well prior to the production operation being performed at the first well;
obtaining a selection of a first depth interval among a plurality of depth intervals in the first well;
determining first predicted production data for the first depth interval in the first well using a first machine-learning model, the selection of the first depth interval, the first well log data, and the first surface production data; and
transmitting a first command to the first well control system at the first well based on the first predicted production data.

17. The system of claim 16, wherein the method further comprises:
determining second predicted production data for a second depth interval among the plurality of depth intervals;
determining whether the second depth interval is experiencing a water breakthrough based on the second predicted production data; and
transmitting a second command to a second well control system,
wherein the second command implements a remediation operation in response to determining that the second depth interval is experiencing the water breakthrough.

18. The system of claim 16, wherein the method further comprises:
determining, using the first well log data, rock matrix porosity data and fracture porosity data for the first depth interval in the first well;
determining, using the first well log data, rock matrix permeability data and fracture permeability data for the first depth interval in the first well; and
determining a petrophysical rock type for the first depth interval,
wherein the rock matrix porosity data, the fracture porosity data, the rock matrix permeability data, the fracture permeability data, and the petrophysical rock type are used by the first machine-learning model to determine the first predicted production data for the first depth interval.

19. The system of claim 16, further comprising:
a water cut sensor coupled to first well control system and the first well;
wherein the method further comprises:
determining a height value above free water level of the first depth interval;
determining first water saturation data of the first depth interval prior to the production operation;
determining second water saturation data for the first depth interval during the production operation; and
determining, using the water cut sensor, water cut data during the production operation,
wherein the height value, the first water saturation data, the second water saturation data, and the water cut data are used by the first machine-learning model to determine the first predicted production data for the first depth interval.

20. The system of claim 16, wherein the method further comprises:
obtaining training data comprising second well log data for a plurality of training wells, second surface production data for the plurality of training wells, and acquired production logging tool (PLT) data for a second plurality of depth intervals for the plurality of training wells,
wherein the acquired PLT data is acquired using a plurality of production logging tools in the plurality of training wells; and
performing a training operation of an initial model using the training data to produce the first machine-learning model.
